(19) United States
(12) Patent Application Publication
(10) Pub. No.: US 2011/0070990 A1
(43) Pub. Date: Mar. 24, 2011

(54) DRIVE SYSTEM

(75) Inventors: Mitsugi YAMASHITA, Anjo (JP); Shoji Takahashi, Anjo (JP); Misaki Kamiya, Anjo (JP); Masayuki Uchida, Anjo (JP)

(73) Assignee: AISIN AW CO., LTD., Anjo-shi (JP)

(21) Appl. No.: 12/851,162

(22) Filed: Aug. 5, 2010

(30) Foreign Application Priority Data
Sep. 18, 2009 (JP) 2009-218121
Dec. 2, 2009 (JP) 2009-274862

(51) Int. Cl. F16H 37/12; F16H 57/04

(52) U.S. Cl. 475/5; 476/8; 903/902; 180/65.21

(57) ABSTRACT

A drive system with a case divided into two oil-tight compartments. The first compartment is filled with traction oil and accommodates a friction type continuously variable transmission (CVT) device, and a second compartment filled with lubricant oil and a gear transmission device formed from a meshing rotary transmission mechanism. The CVT device includes an input member, an output member, and a ring interposed in such a way that the ring moves in an axial direction to steplessly change speeds. An input or output member of the CVT device includes a first axial portion rotatably supported by the case, and a second axial portion supported on a second side of the partition through a bearing that provides support in a thrust and radial direction. The bearing is mounted to the partition so that an inner race of the bearing is unrotatably connected to the second-side axial portion through a rotation stopper.

### INCORPORATION BY REFERENCE

The disclosure of Japanese Patent Application Nos. 2009-274862 and 2009-218121 filed on Dec. 2, 2009 and Sep. 18, 2009, respectively, including the specification, drawings and abstract is incorporated herein by reference in their entirety.

### BACKGROUND OF THE INVENTION

The present invention relates to a drive system that includes: a friction type, such as a cone ring type, continuously variable transmission device; and a gear transmission device formed from a meshing rotary transmission mechanism (such as a toothed gear, a chain, and a sprocket).

### DESCRIPTION OF THE RELATED ART

A conventional drive system, such as a hybrid drive system, is known that integratedly incorporates a continuously variable transmission device and a gear transmission device. A belt type continuously variable transmission device is generally used as the continuously variable transmission device for the hybrid drive system. The belt type continuously variable transmission device is formed from a pair of pulleys and a belt (or chain) made of metal that is wound around the pulleys, and steplessly changes the speed by changing an effective diameter of the pulleys.

Also known is a friction type, that is, a cone ring type, continuously variable transmission device that is formed from a pair of conical friction wheels and a ring made of metal interposed between the friction wheels. By moving the ring so as to change contacting portions between the ring and the friction wheels, the speed is steplessly changed (see Published Japanese Translation of PCT Application No. 2006-501425 (JP2006-501425A), for example).

### SUMMARY OF THE INVENTION

In the conventional drive system, the belt type continuously variable transmission device and the gear transmission device formed from a plurality of gears are both housed inside the same case and lubricated by the same lubricant oil, e.g. ATF or the like.

The cone ring type continuously variable transmission device may also be applied as a continuously variable transmission device for the above drive system. In such case, the belt type continuously variable transmission device can achieve a desired transmission torque even in the presence of lubricant oil; however, in the friction type, that is, the cone ring type, continuously variable transmission device formed from frictional contact between the conical friction wheels and the metal ring, it is difficult to achieve a desired transmission torque with lubricant oil, so the use of specialized traction oil for achieving a sufficient shear torque is preferable.

Therefore, the drive system to which the friction type continuously variable transmission device is applied preferably has a first space that accommodates the friction type continuously variable transmission device, and a second space that accommodates the gear transmission device formed from the meshed rotation transmission mechanism, with the first and second spaces defined in an oil-tight manner by a partition. The first space may be filled with traction oil, and the second space with lubricant oil.

The friction type, that is, the cone ring type, continuously variable transmission device requires the application of a large thrust force (axial force) on the friction wheels, because a large contact pressure is applied between the ring and both friction wheels. Generally, inner races of bearings are press-fit to shafts of the friction wheels and supported by the case in the friction type continuously variable transmission device. However, when the above partition is used, the conical friction wheel is assembled in the following order. A first-side axial portion of the friction wheel is supported by the case to mount the friction wheel, and in this state, the partition is assembled. Then, a bearing is assembled to the partition to support a second-side axial portion of the friction wheel. Given that bearings are preferably provided for receiving the thrust force on the second space side, it is difficult to assemble the partition while the inner races of the bearings are press-fit to both second-side axial portions with the first sides of the friction wheels supported by the case.

In other words, it is difficult in terms of precision to insert an input side and an output side of the friction wheels into bearings that mount the second-side axial portions of both friction wheels to the partition.

Hence, the present invention provides a drive system that solves the above problem by supporting an axial portion of a conical friction wheel subject to a thrust force by a partition on a second space side.

The present invention is a drive system in which a partition divides a case and defines in an oil-tight manner therein a first space that is filled with traction oil and accommodates a friction type continuously variable transmission device, and a second space that is filled with lubricant oil and accommodates a gear transmission device formed from a meshing rotary transmission mechanism. In the drive system, the friction type continuously variable transmission device is a cone ring type continuously variable transmission device including an input member that is formed from a conical friction wheel, an output member that is formed from a conical friction wheel and disposed parallel to the input member such that large diameter portions and small diameter portions of the friction wheels are respectively opposite each other in an axial direction, and a ring that is interposed between opposing inclined surfaces of the friction wheels, wherein the ring is moved in the axial direction to steplessly change a speed. In addition, one of the input member and the output member includes a first-side axial portion that is rotatably supported by the case, and a second-side axial portion that is supported on a second space side of the partition through a bearing that provides support in a thrust direction and a radial direction. Further, the bearing is mounted to the partition, and an inner race of the bearing is unrotatably connected to the second-side axial portion through a rotation stopper.

Note that, in the present invention, the term “gear” refers to a meshing rotary transmission mechanism including toothed gears and sprockets. Thus, the gear transmission device refers to a transmission device that uses the meshing transmission mechanism.

More preferably, the one member is the input member, with the first-side axial portion of the input member on a large diameter portion side of the friction wheel and the second-side axial portion on a small diameter portion side of the friction wheel.

As an example, referring to FIG. 3, the inner race is press-fit to a sleeve. The sleeve includes on an inner diameter side thereof a large diameter dowel portion, a small diameter dowel portion, and a spline portion between the dowel portions. The second-side axial portion is supported with play therebetween by the dowel portions and spline engagement of the spline portion.

As another example, referring to FIG. 4, the inner race includes on an inner diameter side thereof a large diameter dowel portion, a small diameter dowel portion, and a spline portion between the dowel portions. The second-side axial portion is supported with play therebetween by the dowel portions and spline engagement of the spline portion.

As yet another example, referring to FIG. 5, the second-side axial portion is provided with a stepped portion and the stepped portion is provided with one of a projecting portion and a notched portion. A side end surface of the inner race is provided with one of the notched portion and the projecting portion, wherein the second-side axial portion is supported with play therebetween by the inner race, and the projecting portion is engaged and unrotatably connected to the notched portion.

Referring to FIGS. 3 to 5, the second-side axial portion includes a stepped portion and a tip end portion of the second-side axial portion includes an external thread portion. The inner race is fastened between the stepped portion and a nut that is threadedly engaged with the external thread portion such that the inner race is integratedly attached to the second-side axial portion in the axial direction.

The bearing is a tapered roller bearing that supports a thrust force acting in the direction of the large diameter portion of the input member.

The case includes a first case member and a second case member that are mutually joined. The first-side axial portion of the input member is supported by the first case member through a radial bearing. The output member includes a first-side axial portion that is supported by the first case member through a radial bearing, and a second-side axial portion that is supported by the partition through a radial bearing. An axial force application mechanism that applies an axial force corresponding to an output torque is interposed between the output member and an output shaft of the continuously variable transmission device. The output shaft of the continuously variable transmission device is supported on a second space side of the second case member through a tapered roller bearing that supports a thrust force in a reaction direction of the axial force application mechanism.

An input shaft that moves in accordance with an engine, an electric motor that includes a dedicated output shaft, and a differential device are further provided. The friction type continuously variable transmission device steplessly changes a speed of a rotation of the input shaft and outputs such rotation to the output shaft of the continuously variable transmission device. The gear transmission device transmits a rotation of the output shaft of the electric motor to the differential device through the output shaft of the continuously variable transmission device.

According to a first aspect of the present invention, a partition-side axial portion of at least one of a pair of conical friction wheels is supported by an inner race of a bearing with play therebetween using a rotation stopper. Therefore, the axial portion of the pair of friction wheels can be mounted to and supported by a partition through the bearing.

A cone ring type continuously variable transmission device is accommodated in a first space filled with traction oil. The continuously variable transmission device transmits torque in the presence of an oil film of the traction oil, which has a large shear force particularly in an extreme pressure condition. A desired torque can thus be reliably transmitted over a long period of time, and swift and smooth shifting achieved. In addition, a large thrust force acting on one member of the continuously variable transmission device is supported by a bearing that is disposed on a second space side of the partition. Therefore, the bearing is lubricated by the lubricant oil in the second space, and highly precise shaft support can be maintained over a long period of time.

According to a second aspect of the present invention, the one member is an input member, and a large thrust force acts on the partition side. A second-side axial portion that is on a small diameter portion side of the input member is supported by the partition through a bearing that provides support in a thrust direction and a radial direction.

According to a third or a fourth aspect of the present invention, a sleeve or an inner race includes a large diameter dowel portion and a small diameter dowel portion on respective end portions thereof. An intermediate portion of the sleeve or the inner race includes a spline portion. The second-side portion of the input member is supported by the dowel portions with play therebetween and engaged with the spline portion. Therefore, the continuously variable transmission device can be assembled such that the second-side axial portion of the input member is inserted into the partition with sufficient play therebetween, the inner race of the bearing integrally rotates with the axial portion due to spline engagement, and the second-side axial portion is supported by the partition. Both end portions of the axial portion are fittedly supported and the intermediate portion of the axial portion is in spline engagement, whereby the axial portion is suitably supported by the bearing.

According to the third aspect of the present invention, the sleeve is press-fit to the inner race, and the sleeve is formed with the large diameter dowel portion, the small diameter dowel portion, and the spline portion. Thus, for the inner race, an inner race of an ordinary bearing is sufficient, and no special bearing is required.

According to a fifth aspect of the present invention, the rotation stopper of the inner race can be configured using a simple structure in which a notched portion or a projecting portion is formed on the inner race.

According to a sixth aspect of the present invention, the inner race of the bearing is interposed between a stepped portion of the axial portion and a nut so as to integrally rotate in the axial direction. Therefore, a thrust force acting on the input member can be reliably supported by the partition through the bearing.

According to a seventh aspect of the present invention, a unidirectional thrust force that acts on the input member can be reliably supported in a radial direction and by a tapered roller bearing.

According to an eighth aspect of the present invention, the continuously variable transmission device receives an axial force corresponding to an output torque from an axial force application mechanism that is interposed between the output member and an output shaft of the continuously variable transmission device, and a suitable contact pressure enables reliable torque transmission without a large power loss. In addition, the axial force and the thrust force cancel out each other and are supported by the integrated case, so there is no need for an equilibrant force to support the axial force.

According to a ninth aspect of the present invention, the invention can be applied to a hybrid drive system, wherein power from an electric motor is transmitted with high efficiency to a differential device, and a rotation of an engine is steplessly changed in speed in a swift and smooth manner and then transmitted to the differential device. A control is performed such that the electric motor appropriately assists while the engine achieves a swift and suitable output. It is thus possible to provide a hybrid drive system that enables a sufficient fuel economy improvement and carbon dioxide reduction effect with a relatively inexpensive configuration that uses a friction type continuously variable transmission device having a simple constitution.

### BRIEF DESCRIPTION OF THE DRAWINGS

FIG. 1 is a front cross-sectional view that shows a hybrid drive system to which the present invention is applied;

FIG. 2 is a side view of the hybrid drive system;

FIG. 3 is an enlarged front cross-sectional view that shows a support portion of an axial portion on a partition side of an input member;

FIG. 4 is a cross-sectional view that shows a support of the axial portion according to another embodiment; and

FIGS. 5A and 5B show views of a support of the axial portion according to a further modified embodiment, wherein FIG. 5A is a cross-sectional view of an inner race and FIG. 5B is a cross-sectional view as seen along a line B-B in FIG. 5A.

### DETAILED DESCRIPTION OF THE EMBODIMENTS

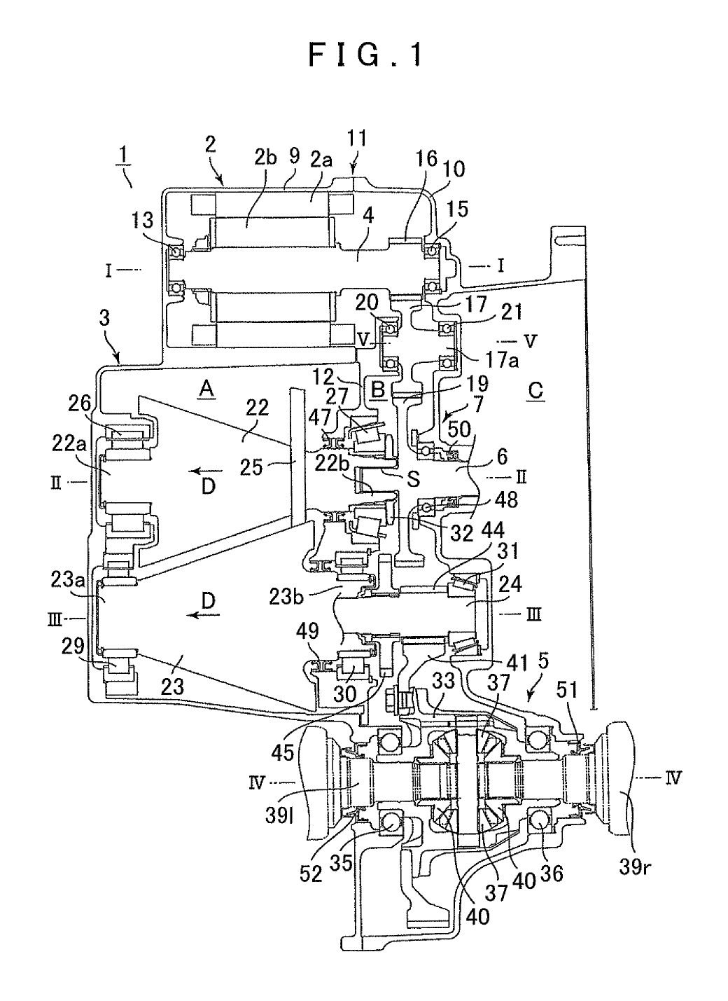

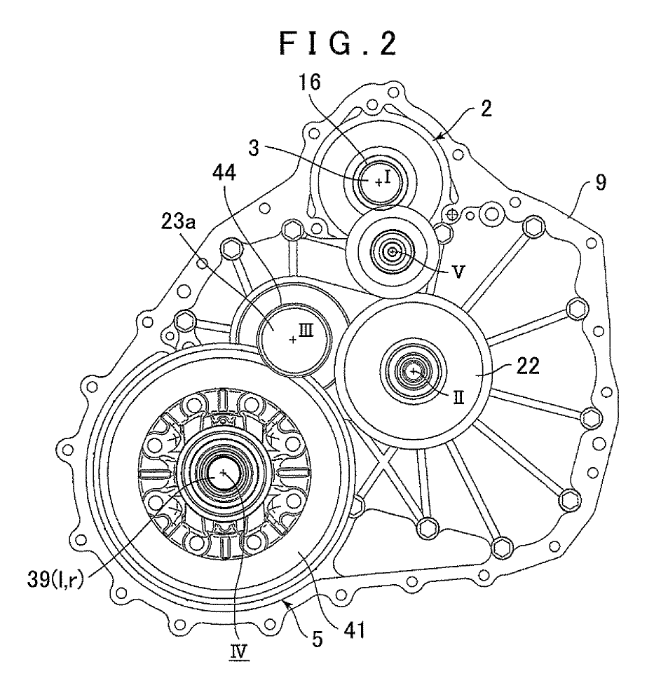

A hybrid drive system to which the present invention is applied will be described below with reference to the attached drawings. As shown in FIGS. 1 and 2, a hybrid drive system 1 includes an electric motor 2, a cone ring type continuously variable transmission device (a friction type continuously variable transmission device) 3, a differential device 5, an input shaft 6 that moves in accordance with an output shaft of an engine (not shown), and a gear transmission device 7. The above devices and shafts are housed in a case 11 that is formed by two case members, that is, a case member 9 and a case member 10. Further, the case 11 includes a first space A and a second space B divided by a partition 12 in an oil-tight manner.

The electric motor 2 includes a stator 2a fixed to the first case member 9, and a rotor 2b provided on an output shaft 4. A first end portion of the output shaft 4 is rotatably supported by the first case member 9 through a bearing 13, and a second end portion of the output shaft 4 is rotatably supported by the second case member 10 through a bearing 15. An output gear 16 consisting of a toothed gear (pinion) is formed on a second side of the output shaft 4, and meshes with an intermediate gear (toothed gear) 19 provided on the input shaft 6 through a toothed idler gear 17.

A shaft 17a of the toothed idler gear 17 includes a first end portion that is rotatably supported by the partition 12 through a bearing 20, and a second end portion that is rotatably supported by the second case member 10 through a bearing 21. The toothed idler gear 17 is disposed partially overlapping with the electric motor 2 in a radial direction when viewed from the side (that is, when viewed in an axial direction).

The cone ring type continuously variable transmission device 3 includes a conical friction wheel 22 serving as an input member, a conical friction wheel 23 serving as an output member, and a ring 25 made of metal. The friction wheels 22, 23 are disposed so as to be mutually parallel, and a small diameter portion and a large diameter portion of the friction wheel 22 is disposed axially opposite to a small diameter portion and a large diameter portion of the friction wheel 23. The ring 25 is interposed between opposing inclined surfaces of the friction wheels 22, 23 and surrounds one of the friction wheels, for example, the input-side friction wheel 22. A large thrust force acts on at least one of the friction wheels, and therefore the ring 25 is interposed between the inclined surfaces by a relatively large clamping force based on this thrust force. Specifically, an axial force application mechanism (not shown) formed of a cam mechanism is formed between the output-side friction wheel 23 and an output shaft 24 of the continuously variable transmission device, on surfaces opposed to each other in the axial direction. The thrust force in a direction shown by an arrow D in the drawing is generated in accordance with the transferred torque, and a large clamping force is generated to act on the ring 25 between the output-side friction wheel 23 and the input-side friction wheel 22 that is supported in a direction that counters the thrust force.

The input-side friction wheel 22 includes a first end portion (large diameter portion) supported by the first case member 9 through a roller bearing 26, and a second end portion (small diameter portion) supported by the partition 12 through a tapered roller bearing 27. The output-side friction wheel 23 includes a first end portion (small diameter portion) supported by the first case member 9 through a roller (radial) bearing 29, and a second end portion (large diameter portion) supported by the partition 12 through a roller (radial) bearing 30. The output shaft 24, which applies to the output-side friction wheel 23 the thrust force acting in the direction shown by the arrow D as described above, includes a second end portion supported by the second case member 10 through a tapered roller bearing 31. An inner race of the bearing 27 is interposed between a stepped portion and a nut 32 on the second end portion of the input-side friction wheel 22, and the thrust force that acts on the input-side friction wheel 22 through the ring 25 in the direction shown by the arrow D from the output-side friction wheel 23 is supported by the tapered roller bearing 27. On the other hand, a reaction force of the thrust force acting on the output-side friction wheel 23 acts on the output shaft 24 in a direction opposite to the direction shown by the arrow D, and the reaction force of the thrust force is supported by the tapered roller bearing 31.

The ring 25 moves in the axial direction by an axial moving mechanism, such as a ball screw, and changes the positions of contact between the ring 25 and the input-side friction wheel 22 and between the ring 25 and the output-side friction wheel 23, so as to steplessly change the speed by steplessly changing a rotation ratio between the input member 22 and the output member 23. The reaction force and the thrust force D corresponding to the transferred torque are canceled out by the tapered roller bearings 27, 31 in the integrated case 11, and an equilibrant force such as a hydraulic pressure is not required.

The differential device 5 includes a differential case 33, and the differential case 33 includes a first end portion supported by the first case member 9 through a bearing 35, and a second end portion supported by the second case member 10 through a bearing 36. A shaft that is perpendicular to the axial direction is attached to the inside of the differential case 33, and bevel gears 37, 37, which serve as differential carriers, are engaged with the shaft. Left and right axle shafts 39l, 39r are supported by the shaft, and bevel gears 40, 40 that mesh with the differential carriers are fixed to the axle shafts. Further, a differential ring gear (toothed gear) 41 having a large diameter is attached to the outside of the differential case 33.

The output shaft 24 of the continuously variable transmission device is formed with a toothed gear (pinion) 44, and the toothed gear 44 meshes with the differential ring gear 41. The motor output gear (pinion) 16, the toothed idler gear 17, the intermediate gear (toothed gear) 19, the output gear (pinion) 44 of the continuously variable transmission device, and the differential ring gear (toothed gear) 41 constitute the gear transmission device 5. The motor output gear 16 and the differential ring gear 41 are disposed overlapping each other in the axial direction, and the intermediate gear 19 and the output gear 44 of the continuously variable transmission device are disposed overlapping the motor output gear 16 and the differential ring gear in the axial direction. Note that, a gear 45, which is engaged with the output shaft 24 of the continuously variable transmission device through a spline, is a parking gear that locks the output shaft when a shift lever is in a parking position. Further, the term “gear” refers to a meshing rotary transmission mechanism including toothed gears and sprockets. In this embodiment, however, the gear transmission device refers to a toothed gear transmission device that is formed by toothed gears only.

The input shaft 6 is supported by the second case member 10 through a roller bearing 48. A first end of the input shaft 6 is engaged (drivingly connected) with the input member 22 of the continuously variable transmission device 3 through a spline S, and a second end side of the input shaft 6 is linked with the output shaft of the engine through a clutch (not shown) housed in a third space C defined by the second case member 10, so that the input shaft 6 moves in accordance with the output shaft of the engine. The second case member 10 is open and connected to the engine (not shown) on a third space C side.

The gear transmission device 7 is housed in the second space B. The second space B is a space between the third space C, and the electric motor 2 and the first space A, in the axial direction. The second space B is defined by the second case member 10 and the partition 12. The shaft-supporting portions (27, 30) of the partition 12 are placed in an oil-tight state by oil seals 47, 49, respectively, and the shaft-supporting portions of the second case member 10 and the first case member 9 are shaft-sealed by oil seals 50, 51, 52. The second space B is configured to be oil-tight, and is filled with a predetermined amount of a lubricant oil such as ATF. The first space A defined by the first case member 9 and the partition 12 is similarly configured to be oil-tight, and is filled with a predetermined amount of a traction oil having a shear force, and a large shear force under an extreme pressure condition in particular.

Referring to FIG. 2, the output shaft 4 of the electric motor 2 is a first shaft I; the coaxially disposed input shaft 6 and the input member 22 of the continuously variable transmission device form a second shaft II; the output member 23 of the continuously variable transmission device and the output shaft 24 thereof form a third shaft III; the left and right axle shafts 39l, 39r form a fourth shaft IV; and the toothed idler gear shaft 17a is a fifth shaft V. These shafts are all arranged parallel and supported by the case 11, and the gears (toothed gears) 16, 17, 19, 44, 41 of the gear transmission device 7 are disposed thereon. The electric motor 2 and the continuously variable transmission device 3 are disposed on a first side in the axial direction of the gear transmission device 7, and a second side of the gear transmission device 7 is connected to the engine. Further, the electric motor 2 and the coaxial first shaft I are positioned the highest, while the differential device 5 and the coaxial fourth shaft IV are positioned the lowest. A portion of the ring gear 41 of the differential device 5 lies within the lubricant oil pooled inside the second space B.

Next, the operation of the hybrid drive system 1 as described above will be explained. The hybrid drive system 1 is connected to an internal combustion engine on the third space C side of the case 11, and the output shaft of the engine is connected to the input shaft 6 through a clutch. The power from the engine is transmitted to the input shaft 6, and the rotation of the input shaft 6 is transmitted to the input-side friction wheel 22 in the cone ring type continuously variable transmission device 3 through the spline S. The power is further transmitted to the output-side friction wheel 23 through the ring 25.

During this transmission, a large contact pressure acts between the friction wheels 22, 23 and the ring 25 due to the thrust force acting on the output-side friction wheel 23 in the direction shown by the arrow D. Because the first space A is filled with the traction oil, an oil film of the traction oil is formed between the friction wheels and the ring, bringing about the extreme pressure condition. In this condition, the traction oil has a large shear force, and thus the power is transmitted between the friction wheels and the ring by the shear force of the oil film. This allows the transfer of a predetermined torque in a non-slip manner without causing wear on the friction wheels and the ring, even though the torque transfer is made through contact between metal members. Moreover, the ring 25 moves in the axial direction smoothly to change the positions of contact between both friction wheels and the ring, whereby the speed is steplessly changed.

The rotation of the output-side friction wheel 23 whose speed has been steplessly changed is transmitted to the differential case 33 of the differential device 5 through the output shaft 24, the output gear 44, and the differential ring gear 41. The power is then distributed to the left and right axle shafts 39l, 39r so as to drive the vehicle wheels (front wheels).

On the other hand, the power from the electric motor 2 is transmitted to the input shaft 6 through the output gear 16, the toothed idler gear 17, and the intermediate gear 19. Similar to the description above, the speed of the rotation of the input shaft 6 is steplessly changed by the cone ring type continuously variable transmission device 3, and the rotation is transmitted to the differential device 5 through the output gear 44 and the differential ring gear 41. The gear transmission device 7 formed by the gears 16, 17, 19, 44, 41, 37, 40 is housed in the second space B filled with the lubricant oil, and therefore the power is smoothly transmitted through the lubricant oil when the gears mesh. At such time, because the differential ring gear 41 (see FIG. 2) disposed at a lower position in the second space B is formed of a large diameter gear, the differential ring gear 41 scoops up the lubricant oil so that a sufficient amount of lubricant oil is reliably supplied to the other gears (toothed gears) 16, 17, 19, 44 and the bearings 27, 30, 20, 21, 31, 48.

Various operation modes of the engine and the electric motor, that is, operation modes as the hybrid drive system 1, may be employed as necessary. As an example, when the vehicle starts off, the clutch is disconnected and the engine stopped so that the vehicle is started using only the torque from the electric motor 2. Once the vehicle speed reaches a predetermined speed, the engine is started and the vehicle is accelerated by the power from the engine and the electric motor. When the vehicle speed becomes a cruising speed, the electric motor goes into free rotation or is placed in a regeneration mode, and the vehicle travels using only the power from the engine. During deceleration or braking, the electric motor regenerates to charge a battery. Further, the vehicle may be started by the power from the engine using the clutch as a starting clutch, with the torque from the motor used as an assisting power.

Next, the shaft support of the conical friction wheel 22 serving as the input member will be described. The input member and the output member, namely, the friction wheels 22, 23, are assembled under the first case member 9 with a vertical direction used as the axial directions thereof. Specifically, first, the friction wheels 22, 23 are assembled to the first case member 9 with outer races thereof press-fit to the first case member 9 and the roller bearings 26, 29 mounted to the first case member 9, and with inner races thereof press-fit to first-side axial portions 22a, 23a (see FIG. 1). In this state, the ring 25 is inserted between the friction wheels 22, 23 so as to surround the input-side friction wheel 22. Then, the partition 12 mounted with the oil seals 47, 49 and the bearings 27, 30 is assembled. The outer race of the roller bearing 30 is press-fit to and retained by the partition, and the inner race is press-fit to and retained on the axial portion, between the second-side axial portion 23b of the output-side friction wheel 23 and the partition 12, to attach the roller bearing 30.

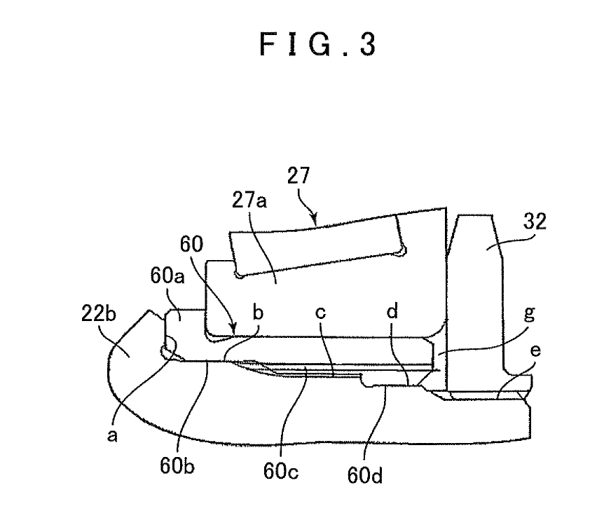

The tapered roller bearing 27 that supports the second-side axial portion 22b of the input-side friction wheel 22 is attached to the partition 12 by press-fitting the outer race of the tapered roller bearing 27 to the partition 12, as well as the roller and the inner race thereof. At such time, as shown in detail in FIG. 3, a sleeve 60 is press-fit to an inner diameter side of an inner race 27a, and integrally fixed to the inner race 27a. The sleeve 60 forms a flange portion 60a of which one end side (a conical side) extends in an outer diameter direction. A large diameter dowel portion 60b, a spline portion 60c, and a small diameter dowel portion 60d are sequentially formed on an inner diameter side of the flange portion 60a from the conical side to a tip end side of the sleeve 60.

On the other hand, the second-side axial portion 22b of the input-side friction wheel 22 is sequentially formed with a stepped portion a, a large diameter support portion b, a spline portion c, a small diameter support portion d, and an external thread portion e from a conical side of the second-side axial portion 22b to a tip end thereof. The partition 12 is assembled so that the second-side axial portion 22b is inserted into the sleeve 60 that is integrally press-fit to the bearing 27. During such assembling, the large diameter dowel portion 60b of the sleeve 60 and the large diameter support portion b of the axial portion 22b are fit to each other with play therebetween, and the small diameter dowel portion 60d and the small diameter support portion d are fit to each other with play therebetween. Further, the spline portions 60c, c are engaged with each other. In this configuration, even with the second-side axial portion 23b of the output-side friction wheel 23 supported by the roller bearing 30 in a state where the inner race of the roller bearing 30 is press-fit to the second-axial portion 23b, the partition 12 can be inserted with the second-side axial portion 22b of the input-side friction wheel 22 because there is play between the sleeve 60 and the second-side axial portion 22b. Further, the external thread portion e is screwed into the nut 32 so as to abut the flange portion 60a of the sleeve 60 against the stepped portion a. The nut 32 is pressed against an outer side face of the inner race 27a, so that the axial portion 22b is tightened to restrict its movement in the axial direction with respect to the bearing 27. At such time, a clearance g is created between tip end portions of the nut 32 and the sleeve 60.

In this state, the second-side axial portion 22b of the input-side friction wheel 22 is fittedly supported by the sleeve 60 integrated with the bearing 27 at both axial end portions and dowel portions thereof. The second-side axial portion 22b is also supported by the spline at an axial intermediate portion so as to integrally rotate. Further, the sleeve 60 and the inner race 27a are interposed between the stepped portion a and the nut 32, and integratedly supported in the axial direction. Therefore, the first-side axial portions 22a, 23a of the friction wheels 22, 23 are supported by the first case member 9 through the bearings 26, 29, and the second-side axial portions 22b, 23b are supported by the partition 12 through the bearings 27, 30.

The input-side friction wheel 22 is fittedly supported by the sleeve 60, which is press-fit to the tapered roller bearing 27, at the dowel portions and the support portions so as to be integrated in the rotational and axial directions. The input-side friction wheel 22 is thus reliably supported while bearing a large thrust force in the direction shown by the arrow D. At such time, due to the fitted state of the partition 12 to the dowel portions and the support portions with play therebetween, the partition 12 is easily inserted and assembled with the axial portions 22b, 23b. In addition, because the bearings 27, 30, and particularly the tapered roller bearing 27 on which a large thrust force acts, are disposed in the second space B filled with lubricant oil, the bearings 27, 30 are lubricated by the lubricant oil and can thus maintain highly precise shaft support over a long period of time. Further, even if the second-side axial portion 22b of the input-side friction wheel 22 is supported by the bearing 27 with play therebetween, the large axial force D from the axial force application mechanism acts on the output-side friction wheel 23. Therefore, a large contact pressure on the ring 25 is constantly maintained, and a radial force in a direction away from the output-side friction wheel 23 based on the thrust force is constantly applied to the ring 25. The dowel portions 60b, 60d and the support portions b, d are in constant contact in the radial direction, thus maintaining the shaft accuracy of the second-side axial portion 22b of the input-side friction wheel (the inter-shaft accuracy between the input-side friction wheel and the output-side friction wheel).

With the partition 12 thus assembled, the input shaft 6 is engaged through a spline (S) with the axial portion 22b of the input-side friction wheel 22, and the second case member 10 is assembled with the electric motor 2, the toothed idler gear 17, the output shaft 24 of the continuously variable transmission device, and the differential device 5 mounted between the partition 12 and the second case member 10.

Next, another embodiment related to the support of the second-side axial portion 22b of the input-side friction wheel 22 will be described.

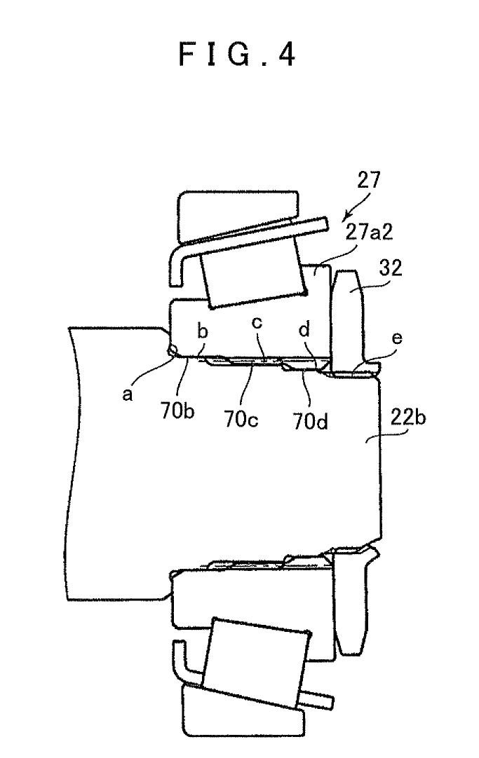

FIG. 4 is a view that shows an embodiment in which an inner race 27a2 of the tapered roller bearing 27 is directly supported by the axial portion 22b without using the sleeve described above.

A large diameter dowel portion 70b, a spline portion 70c, and a small diameter dowel portion 70d are sequentially formed from one end side (a conical side) to a tip end side on an inner side of the inner race 27a2.

On the other hand, as described above, the second-side axial portion 22b of the input-side friction wheel 22 is sequentially formed with the stepped portion a, the large diameter support portion b, the spline portion c, the small diameter support portion d, and the external thread portion e from the conical side of the second-side axial portion 22b to the tip end thereof. The partition 12 is assembled so that the second-side axial portion 22b is inserted into the inner race 27a2 of the bearing 27. During such assembling, the large diameter dowel portion 70b of the inner race 27a2 and the large diameter support portion b of the axial portion 22b are fit to each other with play therebetween, and the small diameter dowel portion 70d and the small diameter support portion d are fit to each other with play therebetween. Further, the spline portions 70c, c are engaged with each other. In this configuration, even with the second-side axial portion 23b of the output-side friction wheel 23 supported by the roller bearing 30 in a state where the inner race of the roller bearing 30 is press-fit to the second-axial portion 23b, the partition 12 can be inserted with the second-side axial portion 22b of the input-side friction wheel 22 because there is play between the inner race 27a2 and the second-side axial portion 22b. Further, the external thread portion e is screwed into the nut 32 so as to abut one end surface of the inner race 27a2 against the stepped portion a. The nut 32 is pressed against an outer side face of the inner race 27a2, so that the axial portion 22b is tightened to restrict its movement in the axial direction with respect to the bearing 27.

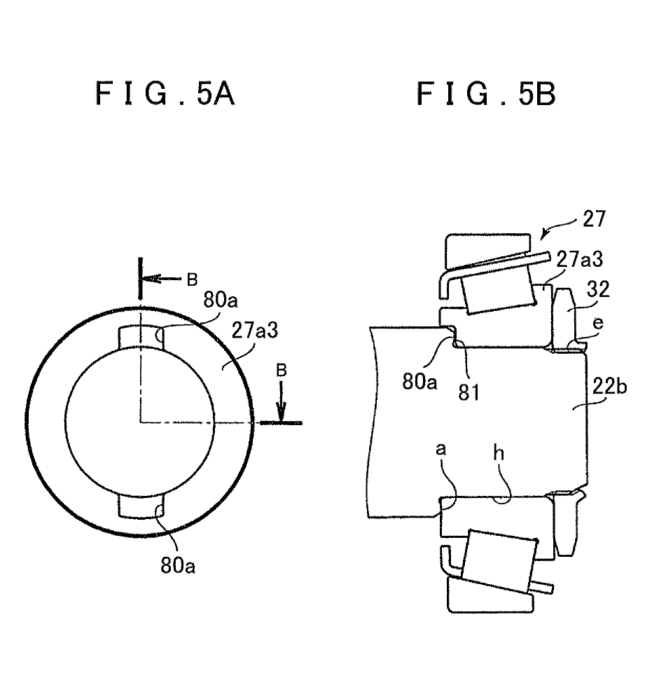

FIGS. 5A and 5B show an inner race 27a3 of the further modified tapered roller bearing 27. One end side (a conical side) of the inner race 27a3 is formed with a notched portion 80a at intervals of 180 degrees. Meanwhile, the stepped portion a is formed on the tip end portion of the second-side axial portion 22b of the input-side friction wheel 22, and a projecting portion 81 is formed on the stepped portion a at intervals of 180 degrees and oriented toward the tip end side. A small diameter side portion h of the stepped portion a is fit with an inner peripheral surface of the inner race 27a3 with play therebetween. Further, the external thread portion e is formed on the tip end portion of the axial portion 22b.

Thus, the stepped small diameter side portion h of the second-side axial portion 22b of the input-side friction wheel 22 is fitted to the inner peripheral surface of the inner race 27a3 with play therebetween, and the projecting portion 81 is joined and unrotatably connected to the notched portion 80a. The inner race 27a3 is then interposed between the stepped portion a and the nut 32, and the nut 32 is fastened with the external thread portion e so as to integratedly attach the bearing 27 to the axial portion 22b in the axial direction. Note that, although the notched portion 80a is directly formed on the inner race in the above description, the notched portion 80a may be formed on a sleeve press-fit to the inner race. Further, the relationship between the notched portion and the projecting portion may be reversed, that is, the notched portion may be formed on the axial portion and the projecting portion may be formed on the inner race or the sleeve.

The spline portion 60c of the sleeve, or the spline portion 70c of the inner race 27a2, is engaged with the spline portion c of the axial portion 22b, and engagement of the notched portion 80a and the projecting portion 81 serves to stop the rotation of the inner race. Note that the configuration for stopping the rotation of the inner race is not limited to that described above, and another configuration such as a key and a key groove may be used.

Further note that, although the above gear transmission device is a toothed gear transmission device that uses toothed gears, a meshing rotary transmission device besides a toothed gear, such as a chain and a sprocket, may be used as a part of the gear transmission device.

The transmission path of the gear transmission device is formed so as to pass through the continuously variable transmission device. However, the transmission path is not limited to this, and the rotation of the electric motor may be transmitted to the differential ring gear 41 without passing through the continuously variable transmission device. In such case, the intermediate gear 19 is rotatably supported by the input shaft 6, and the rotation of the intermediate gear is directly transmitted or transmitted through the idler gear to the output shaft 24 of the continuously variable transmission device.

The above description concerns embodiments in which the drive system is applied as a hybrid drive system. However, the present invention is not limited to this, and may be applied as a drive system other than a hybrid drive system, wherein, for example, another type of gear transmission device, such as a gear transmission device that serves as a reverse gear transmission device, or a planetary gear that separates and transfers a part of torque and combines the torque with an output from the continuously variable transmission device, may be used so as to expand the shift range of the continuously variable transmission device or distribute a part of the transferred torque.

The present invention relates to a drive system that combines a friction type, that is, a cone ring type, transmission device and a gear transmission device, and is utilized as a hybrid drive system installed in an automobile.

What is claimed is:

1. A drive system in which a partition divides a case and defines in an oil-tight manner therein a first space that is filled with traction oil and accommodates a friction type continuously variable transmission device, and a second space that is filled with lubricant oil and accommodates a gear transmission device formed from a meshing rotary transmission mechanism, wherein
the friction type continuously variable transmission device is a cone ring type continuously variable transmission device including an input member that is formed from a conical friction wheel, an output member that is formed from a conical friction wheel and disposed parallel to the input member such that large diameter portions and small diameter portions of the friction wheels are respectively opposite each other in an axial direction, and a ring that is interposed between opposing inclined surfaces of the friction wheels, wherein the ring is moved in the axial direction to steplessly change a speed,
one of the input member and the output member includes a first-side axial portion that is rotatably supported by the case, and a second-side axial portion that is supported on a second space side of the partition through a bearing that provides support in a thrust direction and a radial direction, and
the bearing is mounted to the partition, and an inner race of the bearing is unrotatably connected to the second-side axial portion through a rotation stopper.

2. The drive system according to claim 1, wherein
the one member is the input member, with the first-side axial portion of the input member on a large diameter portion side of the friction wheel and the second-side axial portion on a small diameter portion side of the friction wheel.

3. The drive system according to claim 1, wherein
the inner race is press-fit to a sleeve,
the sleeve includes on an inner diameter side thereof a large diameter dowel portion, a small diameter dowel portion, and a spline portion between the dowel portions, and
the second-side axial portion is supported with play therebetween by the dowel portions and spline engagement of the spline portion.

4. The drive system according to claim 1, wherein
the inner race includes on an inner diameter side thereof a large diameter dowel portion, a small diameter dowel portion, and a spline portion between the dowel portions, and
the second-side axial portion is supported with play therebetween by the dowel portions and in spline engagement with the spline portion.

5. The drive system according to claim 1, wherein
the second-side axial portion is provided with a stepped portion and the stepped portion is provided with one of a projecting portion and a notched portion, and
a side end surface of the inner race is provided with one of the notched portion and the projecting portion, wherein the second-side axial portion is supported with play therebetween by the inner race, and the projecting portion is engaged and unrotatably connected to the notched portion.

6. The drive system according to claim 1, wherein
the second-side axial portion includes a stepped portion and a tip end portion of the second-side axial portion includes an external thread portion, and
the inner race is fastened between the stepped portion and a nut that is threadedly engaged with the external thread portion such that the inner race is integratedly attached to the second-side axial portion in the axial direction.

7. The drive system according to claim 1, wherein
the bearing is a tapered roller bearing that supports a thrust force acting in the direction of the large diameter portion of the input member.

8. The drive system according to claim 1, wherein
the case includes a first case member and a second case member that are mutually joined,
the first-side axial portion of the input member is supported by the first case member through a radial bearing,
the output member includes a first-side axial portion that is supported by the first case member through a radial bearing, and a second-side axial portion that is supported by the partition through a radial bearing,
an axial force application mechanism that applies an axial force corresponding to an output torque is interposed between the output member and an output shaft of the continuously variable transmission device, and
the output shaft of the continuously variable transmission device is supported on a second space side of the second case member through a tapered roller bearing that supports a thrust force in a reaction direction of the axial force application mechanism.

9. The drive system according to claim 8, further comprising:
an input shaft that moves in accordance with an engine;
an electric motor that includes a dedicated output shaft; and
a differential device, wherein
the friction type continuously variable transmission device steplessly changes a speed of a rotation of the input shaft and outputs such rotation to the output shaft of the continuously variable transmission device, and
the gear transmission device transmits a rotation of the output shaft of the electric motor to the differential device through the output shaft of the continuously variable transmission device.

10. The drive system according to claim 2, wherein
the inner race is press-fit to a sleeve,
the sleeve includes on an inner diameter side thereof a large diameter dowel portion, a small diameter dowel portion, and a spline portion between the dowel portions, and
the second-side axial portion is supported with play therebetween by the dowel portions and spline engagement of the spline portion.

11. The drive system according to claim 2, wherein
the inner race includes on an inner diameter side thereof a large diameter dowel portion, a small diameter dowel portion, and a spline portion between the dowel portions, and
the second-side axial portion is supported with play therebetween by the dowel portions and in spline engagement with the spline portion.

12. The drive system according to claim 2, wherein
the second-side axial portion is provided with a stepped portion and the stepped portion is provided with one of a projecting portion and a notched portion, and
a side end surface of the inner race is provided with one of the notched portion and the projecting portion, wherein the second-side axial portion is supported with play therebetween by the inner race, and the projecting portion is engaged and unrotatably connected to the notched portion.

13. The drive system according to claim 10, wherein
the second-side axial portion includes a stepped portion and a tip end portion of the second-side axial portion includes an external thread portion, and
the inner race is fastened between the stepped portion and a nut that is threadedly engaged with the external thread portion such that the inner race is integratedly attached to the second-side axial portion in the axial direction.

14. The drive system according to claim 13, wherein
the bearing is a tapered roller bearing that supports a thrust force acting in the direction of the large diameter portion of the input member.

15. The drive system according to claim 14, wherein
the case includes a first case member and a second case member that are mutually joined,
the first-side axial portion of the input member is supported by the first case member through a radial bearing,
the output member includes a first-side axial portion that is supported by the first case member through a radial bearing, and a second-side axial portion that is supported by the partition through a radial bearing,
an axial force application mechanism that applies an axial force corresponding to an output torque is interposed between the output member and an output shaft of the continuously variable transmission device, and
the output shaft of the continuously variable transmission device is supported on a second space side of the second case member through a tapered roller bearing that supports a thrust force in a reaction direction of the axial force application mechanism.

16. The drive system according to claim 15, further comprising:
an input shaft that moves in accordance with an engine;
an electric motor that includes a dedicated output shaft; and
a differential device, wherein
the friction type continuously variable transmission device steplessly changes a speed of a rotation of the input shaft and outputs such rotation to the output shaft of the continuously variable transmission device, and
the gear transmission device transmits a rotation of the output shaft of the electric motor to the differential device through the output shaft of the continuously variable transmission device.

17. The drive system according to claim 11, wherein
the second-side axial portion includes a stepped portion and a tip end portion of the second-side axial portion includes an external thread portion, and
the inner race is fastened between the stepped portion and a nut that is threadedly engaged with the external thread portion such that the inner race is integratedly attached to the second-side axial portion in the axial direction.

18. The drive system according to claim 17, wherein
the bearing is a tapered roller bearing that supports a thrust force acting in the direction of the large diameter portion of the input member.

19. The drive system according to claim 12, wherein
the second-side axial portion includes a stepped portion and a tip end portion of the second-side axial portion includes an external thread portion, and
the inner race is fastened between the stepped portion and a nut that is threadedly engaged with the external thread portion such that the inner race is integratedly attached to the second-side axial portion in the axial direction.

20. The drive system according to claim 19, wherein
the bearing is a tapered roller bearing that supports a thrust force acting in the direction of the large diameter portion of the input member.
